(19) United States
(12) Patent Application Publication
(10) Pub. No.: US 2023/0222498 A1
(43) Pub. Date: Jul. 13, 2023

(54) PHYSICAL ACTION BLOCKCHAIN

(71) Applicant: Project Noa, Inc., Miami, FL (US)

(72) Inventor: Paul Dohyung Kim, Miami, FL (US)

(73) Assignee: Project Noa, Inc., Miami, FL (US)

(21) Appl. No.: 17/647,833

(22) Filed: Jan. 12, 2022

(51) Int. Cl. G06Q 20/38; G06Q 20/02

(52) U.S. Cl. CPC G06Q 20/389; G06Q 20/027; G06Q 20/0658

(57) ABSTRACT

Techniques are described herein to allow for the utilization of digital currencies in a resource efficient manner, through a physical action blockchain. The physical action blockchain allows for mining/minting of digital currency based on transactions and/or physical actions performed in the real world.

### BACKGROUND

Blockchain based currencies, such as cryptocurrencies of which examples include Bitcoin and Ethereum, have traditionally incurred high transaction and mining barriers. For example, mining of cryptocurrencies are dependent upon computational complexity that require significant amounts of processing resources. Furthermore, such cryptocurrency mining is abstract in that mining is unconnected to real world actions. Such barriers make traditional cryptocurrencies unsuitable for transactions and for compensation for physical real world actions or transactions.

### SUMMARY

Described are methods and systems for a physical action blockchain. The physical action blockchain may be implemented by a system. The system may include a gateway, communicatively coupled to a network, a blockchain including a plurality of data records, a processor, and a memory, communicatively coupled to the gateway, the processor, and the blockchain and configured to cause the processor to perform operations. The operations may include receiving, with the gateway, first transaction data associated with a first transaction, processing, based on the first transaction data, the first transaction, determining that the first transaction is a blockchain mineable event, generating, based on the determining that the first transaction is a blockchain mineable event, a first data record, receiving, with the gateway, second transaction data associated with the first transaction, where the second transaction data indicates that the first transaction has been finalized, and generating, based on the second transaction data, a second data record on the blockchain, where the second data record includes mining data associated with mining of a first resource amount of the blockchain.

Illustrative, non-exclusive examples of inventive features according to the present disclosure are described herein. These and other examples are described further below with reference to figures.

### BRIEF DESCRIPTION OF THE DRAWINGS

The disclosure may best be understood by reference to the following description taken in conjunction with the accompanying drawings, which illustrate various embodiments.

FIG. 1A illustrates a block diagram of an example system, in accordance with some embodiments.

FIG. 1B illustrates a block diagram of an example system, in accordance with some embodiments.

FIG. 2 illustrates examples of geofencing utilized for techniques described herein, in accordance with some embodiments.

FIG. 3 illustrates further examples of geofencing utilized for techniques described herein, in accordance with some embodiments.

FIG. 4 illustrates a block diagram of an example physical action blockchain system, in accordance with some embodiments.

FIG. 5 illustrates a block diagram for a physical action blockchain platform, in accordance with some embodiments.

FIG. 6 illustrates a block diagram for another physical action blockchain platform, in accordance with some embodiments.

FIG. 7 is a process flowchart corresponding to a technique utilizing a physical action blockchain, in accordance with some embodiments.

FIGS. 8-12 are process flowcharts corresponding to further techniques utilizing physical action blockchains, in accordance with some embodiments.

FIG. 13 is a process flowchart corresponding to another technique utilizing a physical action blockchain, in accordance with some embodiments.

FIG. 14 is an example blockchain, in accordance with some embodiments.

FIG. 15 illustrates a block diagram of an example of a physical action blockchain, in accordance with some embodiments.

FIG. 16 illustrates a block diagram of an example computing system, in accordance with some embodiments.

FIG. 17 illustrates an example of a neural network, configured in accordance with some embodiments.

### DETAILED DESCRIPTION

In the following description, specific details are set forth to provide illustrative examples of the systems and techniques described herein. The presented concepts may be practiced without some, or all, of these specific details. In other instances, well known process operations have not been described in detail to avoid unnecessarily obscuring the described concepts. While some concepts will be described with the specific examples, it will be understood that these examples are not intended to be limiting.

Some embodiments of the disclosed systems, apparatus, methods and computer program products are configured for implementing a physical action blockchain. As described in further detail below, such a system may provide for a blockchain and digital currency that is responsive to real world actions or transactions. Such a physical action blockchain allows for mining of digital currency based on real world actions or transactions. Such mining avoids the complicated computational algorithms that are currently being used to mine digital currency, saving significant processing resources for the mining of digital currency.

Furthermore, the techniques described herein allow for frictionless transactions utilizing such currencies and for such currencies to be allocated, transferred, and/or exchanged in a resource efficient manner. For example, typical transactions that utilize cryptocurrencies require large amounts of processing and memory resources to record transfers, requesting in large transaction fees. The techniques described herein allow for cryptocurrency transactions in a memory efficient manner, allowing for frictionless use of cryptocurrencies. Furthermore, the systems described herein utilize a system structure supporting cryptocurrencies where cryptocurrencies can be backstopped. Backstopping of cryptocurrencies increases the usefulness of cryptocurrencies, but requires specific interactions between specific system components to function in a processing and memory efficient manner. The techniques described herein allow for processing and memory efficient backstopping of cryptocurrencies.

Typical blockchains that are tied to digital assets are mined with many thousands of digital miners, where each digital miner consumes energy to compete for rewards of digital assets. Mining of such digital assets consume an incredible amount of electrical power, most of it wasted, and lead to high costs to the miners and to the environment, as power generation leads to greenhouse gases and environmental damage. By contrast, a physical action blockchain creates data records based on real world transactions and/or physical actions and allows for the mining of digital assets via real world actions, instead of through digital mining. Such techniques, as they avoid the need to utilize processing to solve complicated algorithms, conserve significant processing resources. Thus, compared to traditional blockchains, physical action blockchains provide for conservation of power and allows for a blockchain configuration that more directly interfaces real world actions. Furthermore, digital asset may be mined through performance of real world actions, instead of needing to set up complicated mining rigs that cost many thousands of dollars. Also, the techniques described herein may be utilized for transactions that include a plurality of steps to finalize, such as payment card transactions. As such transaction typically include a plurality of steps to finalize, the techniques describe herein may allow for resource efficient techniques to utilize such transaction to mine or mint digital currency.

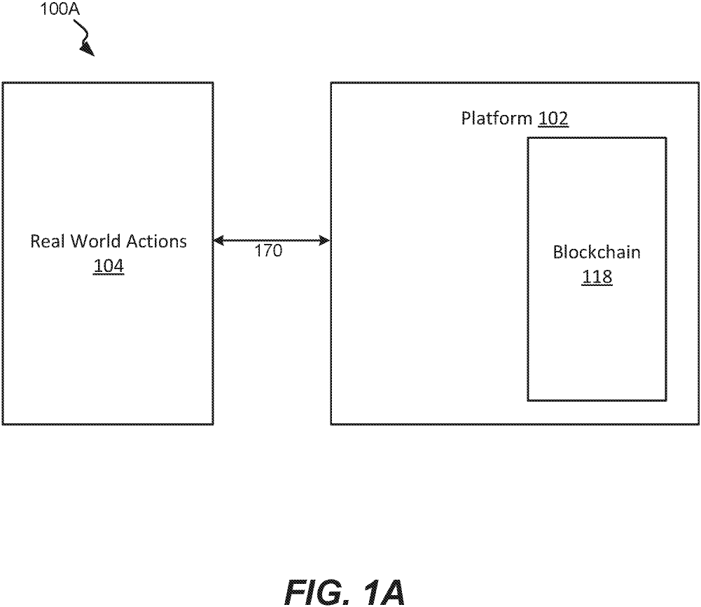

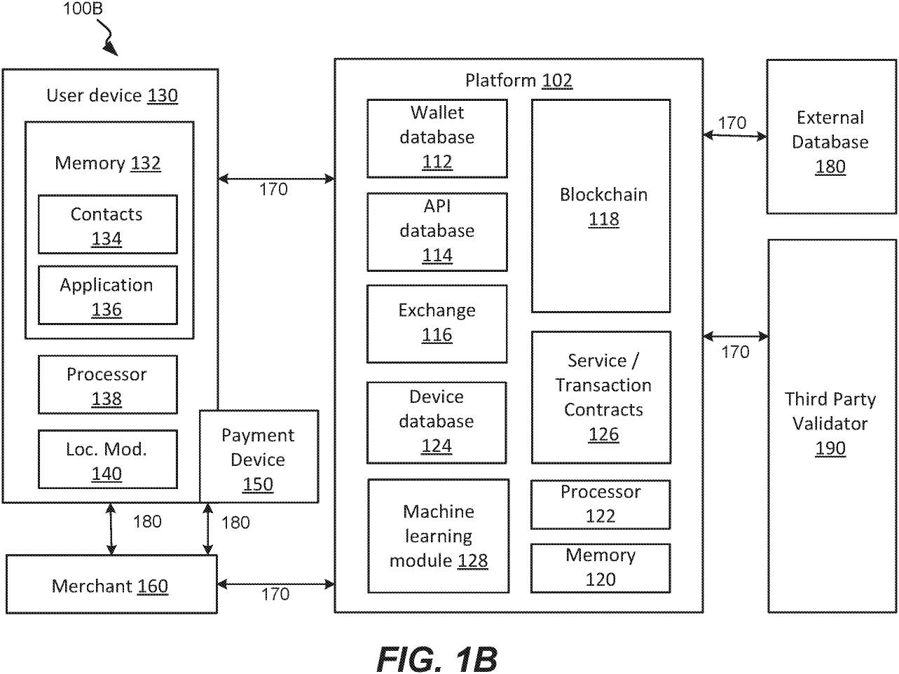

FIG. 1A illustrates a block diagram of an example system, in accordance with some embodiments. FIG. 1A illustrates system 100A that includes platform 102 and real world actions 104 (which may include real world transactions). Platform 102 may include blockchain 118. Blockchain 118 may be a blockchain that underpins one or a plurality of digital currencies.

As shown in system 100A, real world actions 104 are communicated to platform 102 via data connection 170. Data connection 170 may be any type of wired or wireless connection that may provide for communication of data. Real world actions 104 may be actions and/or transactions that are performed within the real world (e.g., originating off of blockchain 118). Real world actions 104 may, for example, be labor performed by a user, a transaction conducted by a user (e.g., via a payment card or another form of payment), actions performed by a user, and/or other such real world connected actions. For the purposes of this disclosure, it is contemplated that any real world actions that may be detected (e.g., via an electronic device or a payment processing service) may be such real world actions 104.

In system 100A, data indicating the performance of real world actions 104 may be communicated to platform 102. Platform 102 may then determine if such actions result in the mining or transfer of digital currency and, if the determination is positive, accordingly create and/or change data records on blockchain 118. As such, performance of real world actions 104 may result in recordation of data records on blockchain 118 and, thus, the mining and/or transfer of digital currency on blockchain 118. Such techniques are further described in the current disclosure.

FIG. 1B illustrates a block diagram of an example system, in accordance with some embodiments. FIG. 1B illustrates system 100B that includes user device 130, platform 102, merchant 160, external database 180, and third party validator 190. Some or all of the various components described herein may be implemented with a combination of processors, memories, and APIs.

User device 140 may be an electronic device of a user. Such a user may be, for example, a purchaser of an item (e.g., an item purchased via payment device 150) and/or a user performing a physical action. In various embodiments, user device 130 may be, for example, a desktop computing device, a portable computing device (e.g., laptops, tablets, smartphones, and/or other electronic devices), a wearable device, other such electronic devices, a payment instrument (e.g., credit card), and/or another such device.

In various embodiments, the user may include payment device 150. Payment device 150 may be a payment instrument separate from user device 130, such as a payment card (e.g., credit card, debit card, preloaded value card, and/or another such card that may be utilized for transactions) or a payment instrument integrated within user device 130 (e.g., an app that allows for payment). In various embodiments, use of payment device 150 may result in the creation of data records on blockchain 118 and the consequent mining of digital currency though the usage of payment device 150. In certain embodiments, payment device 150 may be integrated within user device 130. That is, payment device 150 may be tokenized (e.g., within a wallet or payment application) data and/or other such data associated with the account of payment device 150 that may be otherwise stored or referred to within user device 130. As such, payment may be electronically provided by payment device 150 via user device 130 through one or more payment device communications techniques (e.g., provided via Near Field Communications, Bluetooth, QR code scanning, and/or another such technique).

User device 130 may include memory 132, processor 138, and location module 140. Processor 138 may be configured to perform one or more operations of the techniques described herein. Processor 138 may be any type of single or multi-core processor that allows for electronic data processing.

Location module 140 may be configured to determine a location of user device 130. In various embodiments, location module 140 may be, for example, a global positioning system (GPS) device, an accelerometer, a gyroscope, a signal triangulation device, and/or another such device that allows for determination of a location of user device 130. In various embodiments, one or more techniques may be used individually or in combination to determine the location of user device 130. Location module 140 may be configured to generate location data indicating the location of user device 130. Such location data may be communicated to other devices (e.g., platform 102) via network 170.

Memory 132 may be any type of memory device configured to store data and/or instructions. Memory 132 may be, for example, a harddrive, a solid state device, and/or random access memory (RAM) and may include transitory or non-transitory computer-readable media. Memory 132 may be configured to store contacts 134 and/or application 136.

Application 136 may be stored within memory 132. Application 136 may be, for example, an application configured to allow a user to shop from various retailers and provide payment for goods or services (e.g., via payment device 150), as described herein. Additionally or alternatively, application 136 may allow users to perform actions (e.g., delivery) that may result in the creation of data records on blockchain 118 and, accordingly, allow for the mining and/or transfer of digital currency. Application 136 may also be configured to authenticate the user of user device 130 and, in certain embodiments, issue payment device 150 to the user via application 136 (e.g., the user may apply for a payment device associated with the user via application 136 and application 136 may provide such a payment device). Thus, application 136 may be used to verify the identity of the user, who may be performing and/or requesting the real world action or transaction. Application 136 may also allow for viewing of blockchain records on blockchain 118 (e.g., for validation).

Network 170 may be any wired or wireless communications connection that allows for data to be communicated. Network 170 may be, for example, a wired Ethernet connection or a wireless connection such as WiFi, 3G, 4G, 5G, or another such connection that allows for data to be transmitted. In various embodiments, the various components of the systems described herein may utilize one, some, or all of such data connections to communicate and/or receive data.

In various embodiments, application 136 may provide user data to platform 102 (e.g., due to an action or transaction). Such user data may be utilized during processing of the transaction, during mining/minting of the digital currency, during other operations on blockchain 118, and/or during other techniques. Additionally or alternatively, user data may also be provided by external database 180 (via network 170 to platform 102) and/or stored within a database of platform 102 (e.g., device database 124 may also be associated with various users of platform 102).

Platform 102 includes wallet database 112, API database 114, exchange 116, blockchain 118, memory 120, processor 122, device database 124, service contracts 126, and machine learning module 128. The various components of platform 102 may be implemented on a server and/or on the cloud. In certain embodiments, the implementations may be physical, cloud resources utilizing various scalable or non-scalable system architectures, and/or other architectures including container architectures.

Processor 122 may be a single or multi-core processor, as described herein, configured to allow for platform 102 to perform the operations described herein. Memory 120 may be any type of memory device configured to store data and/or instructions. Processor 122 and memory 120 may be system resources to allow the operation and performance of the various techniques associated with platform 102 (e.g., maintenance of blockchain 118 and/or serving of API database 114). Processor 122 may also perform various aspects of the techniques described herein, such as the processing of transactions (e.g., transactions between the user of user device 130 and merchant 160). Processor 122 may accordingly operate based on instructions received from memory 120 to perform such techniques.

Wallet database 112 may be configured to maintain and/or provide wallet services to users of platform 102 (e.g., the user associated with user device 130). For example, wallet database 112 may be configured to store one or more accounts associated with the various users of platform 102. Each wallet account may be associated with a specific user. The wallet accounts may store and/or indicate a user balance on platform 102. The accounts stored on wallet database 112 may be denominated in one or more currencies such as US dollars, one or more cryptocurrencies, currencies of other countries, and/or other such currencies.

In various embodiments, wallet database 112 may be configured to provide payment for transactions on platform 102 and/or may provide for rewards for transactions conducted on platform 102 (e.g., through usage of payment device 150). In certain embodiments, wallet database 112 may be configured to interface with one or more external accounts or exchanges. Wallet database 112 may be configured to transfer funds to such external accounts or exchanges (e.g., if an account holder wishes to transfer their funds outward or exchange one currency for another currency) by, for example, indicating on a blockchain that the external account has ownership of a number of coins and/or by transferring funds to the external accounts or exchanges. Wallet database 112, when transferring to an exchange, may be configured to receive value in return for exchanges and may apply that value to the transferring account.

API database 114 may be a database that includes one or more APIs. Such APIs may allow for users, merchants, and/or third parties to interface with platform 102. Accordingly, for example, users may utilize platform 102 to purchase items and/or perform or request physical actions. Additionally or alternatively, APIs may allow for other services to utilize blockchain 118 of platform 102.

Blockchain 118 may be a physical action blockchain. Blockchain 118 may, thus, allow for physical action based mining and/or transactions to be conducted and verified on the blockchain, or verified by third party validator 190. Third party validator 190 may be, for example, a third party that has a stake within the digital assets associated with blockchain 118 and may provide verification or validation services for the data records on blockchain 118. Blockchain 118 may include data records associated with the mining, transfer, and/or ownership of digital currency.

Certain mining and/or transfer actions may require a plurality of data records that are associated with each other. For such mining and/or transfers with a plurality of data records, subsequent data records may be appended onto blockchain 118. Such data records may include payment device data, sensor data, location data, and/or other data indicative of physical actions or transactions. In various embodiments, the blockchain may store such data or may indicate where such data is stored in a third party database. Such data may be utilized to determine the validity of an asserted physical action, according to the techniques described herein. Based on such a determination, blockchain 118 may then be appended with a data record indicating the determination and, where the labor request has been performed, transferring the compensation amount to the labor provider.

In certain embodiments, blockchain 118 may reference or store service contracts 126. Service contracts 126 may be contracts for performing physical actions and/or contracts for transactions. While certain embodiments may include service contracts 126 on blockchain 118 (e.g., as a portion of a data record on blockchain 118), other embodiments may store service contracts 126 in a separate database and data records on blockchain 118 may refer to the appropriate service contract for the associated labor request. Thus, in embodiments where service contracts 126 are stored in a separate database, the separate database may be an extension of blockchain 118. The service contract may indicate the various parameters of various contracts.

Device database 124 may be a database configured to store data from electronic devices of users and/or labor providers. Thus, platform 102 may receive such data and store such data within device database 124. Blockchain 118, in one or more data entries, may then refer to such data within device database 124.

Exchange 116 may be an exchange configured to allow for users of platform 102 to exchange various currencies. Thus, for example, digital assets may be exchanged for physical currency (e.g., US dollar) or vice versa via exchange 116, according to the techniques described herein.

Machine learning module 128 may be an algorithm, neural network, artificial intelligence network, and/or another such module that may be used for machine learning techniques described herein. Machine learning module 128 may be configured to receive data from one or more sources and may be configured to determine one or more relationships and/or other such regressions to optimize outputs for various inputs. Machine learning module 128 may, thus, be trained with data provided to improve the accuracy, efficiency, and/or general quality of outputs.

Merchant 160 may be, for example, a provider of an item or service for purchase. Merchant 160 may include a merchant device such as an electronic device configured to communicate data with platform 102. Such an electronic device may be, for example, a point of sale device. Thus, the user may provide payment for items purchased from merchant 160 with a payment application of user device 130 and/or via payment device 150. Such payment may be provided via payment device communication 180 which may, for example, include data communicated to the point of sale device of merchant 160 (e.g., via a scan or swipe of a payment card).

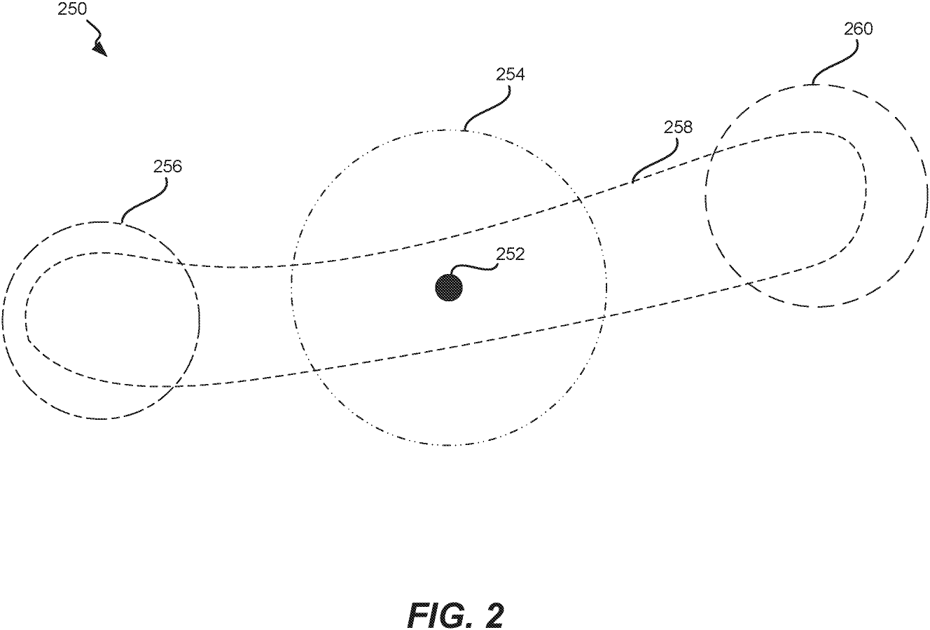

FIG. 2 illustrates examples of geofencing utilized for techniques described herein, in accordance with some embodiments. FIG. 2B illustrates example 200 with user 252. In example 200, a plurality of geofences 254, 256, 258, and 260 may be erected. Geofences 254, 256, 258, and 260 may correspond to various jurisdictions (e.g., countries, states, cities, and/or other such regions) and may be of any appropriate shape. Various jurisdictions may include different rules for the provision of rewards (e.g., rewards for the usage of stored value cards) and/or for digital currency mining and/or transfers. The user device (e.g., via location data provided in connection with a transaction) and/or payment device (e.g., via data received from the point of sale device interacting with the payment device, such as data provided by the merchant indicating the identity and/or location of the merchant upon the processing of the payment device) may provide location data to the platform upon a physical action being performed (e.g., provided via data indicating the physical action, such as transaction data). The platform may then make a determination as to the jurisdiction that the user is located within and/or that the transaction was conducted within.

User 252 may be conducting a transaction within geofences 254 and 258, indicating location within the corresponding jurisdictions of geofences 254 and 258. The platform receives data indicating that user 252 is within geofences 254 and 258. Based on user 252 being within the jurisdictions of geofences 254 and 258, the platform may adhere to the regulations concerning digital currency transfer and/or mining for such jurisdictions, for the physical action and/or transaction of user 252. Thus, for example, geofence 254 may allow for the mining of digital currency and, thus, the platform may allow for transactions of user 252 to mine digital currency. However, in certain embodiments, the jurisdiction associated with geofence 258 may not allow for the mining of digital currency. Accordingly, in such an embodiment, as one of the jurisdictions that user 252 is within does not allow for the mining of digital currency, transactions that user 252 engages in within such a jurisdiction may not result in the mining of digital currency. Furthermore, the platform may determine that user 252 is not within geofences 256 and 260 and the regulations associated with the jurisdictions of geofences 256 and 260 may not need to be adhered to.

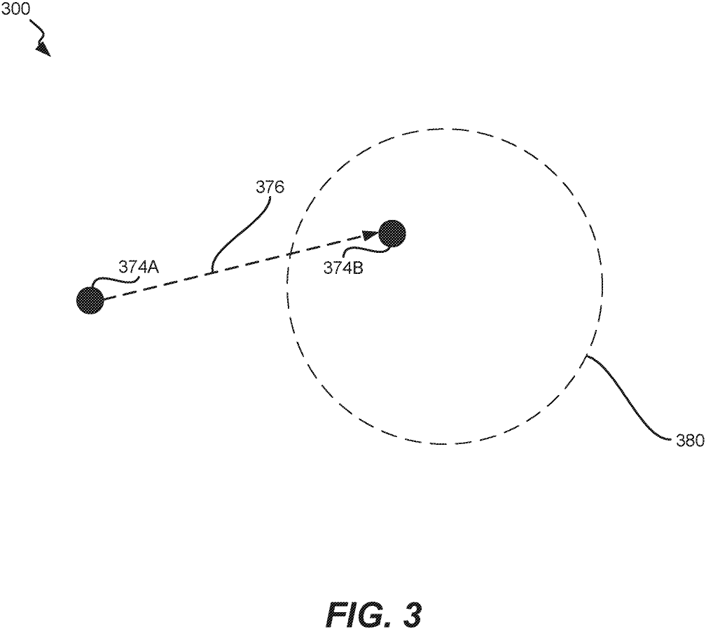

FIG. 3 illustrates further examples of geofencing utilized for techniques described herein, in accordance with some embodiments. FIG. 3 illustrates example 300 where the user starts in location 374A and travels along route 376 to location 374B within geofence 380. In various embodiments, location data and/or transaction data may be received by the platform. The platform may initially not adhere to the regulations of the jurisdiction associated with geofence 380. When the platform determines that the user has moved to location 374B within geofence 380, the regulations of the jurisdiction associated with geofence 380 may be adhered to. Thus, for example, the jurisdiction associated with geofence 380 may not allow for mining of digital currency. When the user is detected to be at location 374A, such regulations may not be adhered to, but when the user is detected at location 374B within geofence 380, transactions and/or physical actions of the user may not result in the mining of digital currency.

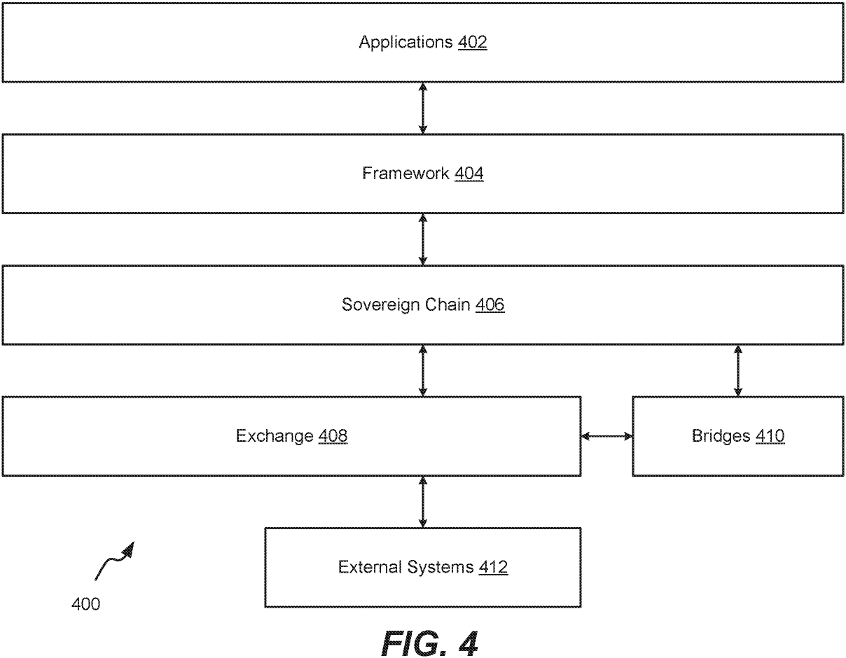

FIG. 4 illustrates a block diagram of an example physical action blockchain system, in accordance with some embodiments. FIG. 4 illustrates system 400 that includes applications 402, framework 404, sovereign chain 406, exchange 408, bridges 410, and external systems 412.

Applications 402 may be an application on an electronic device, as described herein. Applications 402 may include any application associated with any one of the service provider associated with the platform, retailers/merchants, users of the platform, the custodian, and/or other entities associated with systems and techniques described herein. Thus, for example, applications 402 may include, for example, a merchant/item searching and ordering system, a payment system, a wallet system, and/or an application associated with communications with a custodian. Applications 402 may include one or more APIs as described herein.

Such APIs may, for example, allow for a user to purchase one or more items from a retailer, using any currency described herein. The API may also allow for the user to arrange for fulfillment and/or to provide such fulfillment. The API may, accordingly, allow for users to access one or more processes of the platform and/or framework 404 as well as access one or more databases of the platform and/or framework 404.

Applications 402 may communicate with framework 404. Framework 404 may receive communications from applications 402 of various electronic devices and provide for an output based on the data received. Thus, framework 404 may include an API gateway as well as databases/memory and a processor configured to perform the actions described herein. In various embodiments, framework 404 may include applications that allow for the allocation of and/or transactions utilizing cryptocurrency or digital currency as described herein. Thus, for example, framework 404 may include a database that includes the wallets of various users and/or accounts (e.g., merchant accounts) of the platform. Framework 404 may, thus, allocate digital currency, conduct transactions that involve the digital currency (e.g., for payment), exchange digital currency for another currency, and/or conduct other transfers that involve such digital currency. Framework 404 may further include a ledger that may record transactions. The ledger may record one, some, or all transactions on the platform and may, for example, function as temporary memory storage for a blockchain. In certain embodiments, framework 404 may include one or more security components. Such security components may be configured to authenticate various users, transactions, and/or transfer/exchange requests received by framework 404.

In various embodiments, framework 404 may determine, for an allocation, transaction, or exchange, if a blockchain record event has occurred. Such a determination may be according to the techniques described herein. If a blockchain record event has occurred, a handshake may occur between the ledger and the blockchain. Based on the handshake, the allocation, transaction, and/or exchange may be recorded onto a blockchain, such as sovereign chain 406, according to various techniques.

Sovereign chain 406 may be a blockchain associated with one or more digital currencies. Sovereign chain 406 may be a chain based on, for example, a substrate system. Sovereign chain 406 may indicate the various allocations and transfers of the digital currency. In certain embodiments, sovereign chain 406 may only indicate transfers meeting certain conditions. Thus, for example, sovereign chain 406 may only indicate ownership and/or transfers where an amount of the digital currency is associated with an external account (e.g., external wallet account) outside of the databases of the platform (e.g., of framework 404). Sovereign chain 406 may indicate transactions and/or transfers of the amount of the digital currency outside of the ecosystem of the platform.

Thus, sovereign chain 406 may interface with exchange 408 for exchanging digital currency into other currency. Exchange 408 may be an open market where users may exchange and/or receive digital currency for other currencies. In certain embodiments, exchange 408 may be backstopped by a custodian (e.g., backstop entity). Backstop entity may provide for exchange at a previously agreed upon rate if the exchange rate of the digital currency is lower than a threshold amount. In certain embodiments, the backstop entity may be the entity associated with the platform.

Sovereign chain 406 may additionally interface with bridges 410. Bridges 410 may allow integration of other blockchains with sovereign chain 406 or vice versa. Thus, for example, other parachains may integrate with sovereign chain 406 (e.g., via nodes within sovereign chain 406) to allow other parachains to integrate aspects of the ecosystem of sovereign chain 406.

External systems 412 may be other external systems such as that of merchants, custodians, and/or other such entities. External systems 412 allow for decentralized operations within system 400 and, thus, not all entities and/or operations need to be on the platform to take advantage of aspects of the platform. Nonetheless, all transactions or exchanges utilizing the digital currency, including transactions external to the platform, may be recorded within the blockchain of the digital currency.

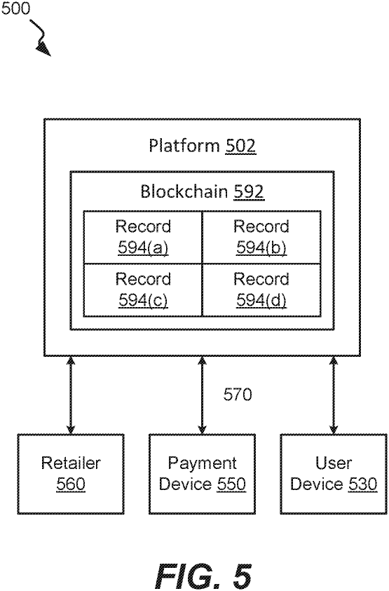

FIG. 5 illustrates a block diagram for a physical action blockchain platform, in accordance with some embodiments. FIG. 5 illustrates system 500 that includes platform 502, user device 530, payment device 550, and retailer 560. Communications between the various components of system 500 may be via communications channel 570, which may include any communications techniques described herein. Platform 502, user device 530, payment device 550, and retailer 560 may be similar to platforms, user devices, payment devices, and/or retailers described herein.

In certain embodiments, platform 502 may include blockchain 592. Blockchain 592 may be associated with a digital currency. The digital currency may be associated with platform 502. Thus, for example, the digital currency may be a digital currency (also known as a cryptocurrency) configured for transactions on platform 502 and/or allocated as compensation (e.g., as rewards) for usage of payment device 550 in manners associated with platform 502 (e.g., platform 502 may process the transactions that utilize payment device 550). Thus, for example, the user may utilize payment device 550, which may be a separate payment device (e.g., payment card) or may be a payment device within user device 530 (e.g., a payment application) for a transaction with retailer 560. Usage of payment device 550 on platform 502 may result in the mining of digital currency on blockchain 592, according to the techniques described herein.

Blockchain 592 may include any number of records, such as records 594(a) to 594(d). Records 594(a) to 594(d) may include data directed to mining and/or transfers of a digital currency associated with blockchain 592. Thus, for example, records 594(a) to 594(d) may include data directed to the details of transactions (e.g., parties involved, identity of the accounts of the parties involved, amount involved, items purchased, time of transaction, fulfillment provided, merchant involved, status of transaction such as open, closed, and/or pending, and/or other such details) that may result in mining of the digital currency and/or transfer of the digital currency.

In certain embodiments, each transaction on blockchain 592 may be uniquely identified (e.g., the various transaction do not sure the same record identification numbers and, thus, are each uniquely identified). In certain such embodiments, the corresponding record on blockchain 592 for the transaction may be updated a plurality of times through appending of additional data to the record, based on additional developments in the transaction (e.g., as the transaction proceeds through a set of steps such as initialization, agreement, payment, delivery, and confirmation). Such data may be appending to the record and, thus, a single record is used for a single transaction.

In another embodiment, a plurality of records may be associated with a single transaction. Thus, as the transaction proceeds, additional records are generated for additional developments in the transaction. However, such additional records may refer to one another, such as referring to the record number of the initial record created for the transaction, to the various records previously created for the transaction, and/or refer to an identification created for the unique transaction (e.g., each such record may include the identification number for the transaction). As such, the various data records of a transaction may each be identified as belonging to the transaction.

In certain embodiments temporary storage may be utilized for transactions with payment device 550. In such embodiments, the amount of digital currency provided may not be mined, minted, and/or other permanently placed into circulation until later confirmation. Temporary storage may allow for such transactions to be first recorded. The transactions may then be recorded on blockchain 592 and the digital currency accordingly mined, minted, and/or other permanently placed into circulation upon a determination that certain conditions are met (e.g., that the transaction has posted). Such a technique may reduce the number of data records present on blockchain 592 for currency that is not otherwise permanently placed into circulation, reducing the size and resources required for maintenance of blockchain 592. Such a technique may also reduce or eliminate the amount of unnecessary validations of records on blockchain 592, such as validation of records on blockchain 592 that, due to a later determination that the associated transaction or physical action is not a blockchain mineable event, does not result in the actual mining/minting of digital currency. Accordingly, processing and/or validation resources may be accordingly further conserved, in contrast to traditional blockchain techniques that are wasteful as each data record is immediately written and validated.

In certain embodiments, one or more of records 594(a) to 594(d) may be directed to transfers external to platform 502 (e.g., transfers of an amount of the digital currency to a wallet external to platform 502, transfers of an amount of the digital currency between different external accounts, and/or transfers of an amount of the digital currency back into platform 502). The records of blockchain 592 may be publicly available and/or available with limited access to one or more other parties.

In various embodiments, creation of one or more of records 594(a) to 594(d) may include validation of the details of the transaction underlying the record(s). Thus, for example, a record may be a pending data record (e.g., on blockchain 592 and/or in temporary storage) as platform 502 confirms the details of the transaction. When platform 502 confirms the details of the transactions, the pending record may be permanently recorded as a data record on blockchain 592. In certain embodiments, platform 502 may correct portions of the data record if certain details are inaccurate. Creation, confirmation, and/or correction of records of records of blockchain 592 may be automatically performed by portions of the platform or systems as described herein.

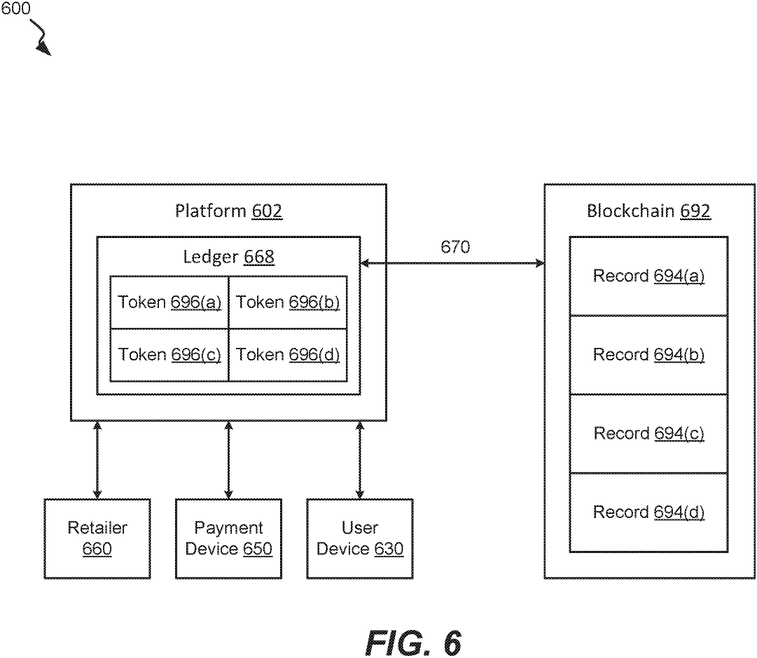

FIG. 6 illustrates a block diagram for another physical action blockchain platform, in accordance with some embodiments. FIG. 6 illustrates system 600. System 600 may include user device 630, payment device 650, and retailer 660, similar to user device 530, payment device 550, and retailer 560 described herein. In system 600 though, platform 602 may include ledger 668 and blockchain 692 may be associated with ledger 668. Data communications between various aspects of system 600 may be via communications channel 670, which may be similar to other communications channels described herein.

Ledger 668 may be temporary storage for one or more transactions that may result in the transfer and/or mining of digital currency. Ledger 668 may store data associated with such transactions until the transaction are permanent (e.g., irrevocable). Once such transactions are determined to be permanent, such data may be communicated to blockchain 692 and created as a data record (e.g., one or more of records 694(a) to (d)) on blockchain 692.

In certain such embodiments, various transactions or aspects thereof may be requested and/or tracked with tokenized data, such as through utilization of a “transaction token” (e.g., a transaction token may replace sensitive transaction details with that of non-sensitive data and/or utilize data requiring a key stored external to the transaction token, such as on the platform, to decipher). Such tokenized data may include providing for unique identifiers for the transaction, the merchant, the customer, the amount, and/or other details of the transaction. In various embodiments, the unique identifiers may be persistent (e.g., in the case of a merchant) and/or may be uniquely generated for each transaction (e.g., in the case of a customer, the platform may generate a different unique identifier for a customer for each transaction that the customer participates in and use the unique identifier for the specific transaction, to preserve anonymity. Accordingly, for example, tokenized data may be generated when a transaction is requested (e.g., when payment from payment device 650 is requested). The tokenized data, or a copy of the tokenized data, may be provided to user device 630, retailer 660, and/or to a payment provider associated with payment device 650 (e.g., a bank) to track the progress of the transaction. The tokenized data may indicate the parties of a transaction, such as the retailer and/or the customer as well as indicate the items purchased, the fulfillment provided, the cost of the purchases, the type of payment provided for the transaction, and/or other aspects of the transaction.

Tokenized data may be processed, modified, or updated based on the status of the transaction. In certain embodiments, processed, modified, or updated tokenized data may be received from various parties of the transaction during various stages of the transaction (e.g., when payment has been fully processed). For example, the received tokenized data may be an updated transaction token indicating delivery of the item purchased. The updated transaction token may be a transaction token with data updated by, for example, a user device. In certain embodiments, ledger 668 may receive the transaction token and determine details of the update (e.g., whether the terms of the transaction has been fulfilled) from the transaction token.

In other embodiments, ledger 668 may, alternatively or additionally, store the transaction tokens received. In certain such embodiments, ledger 668 may be updated with such updated transaction tokens (e.g., the tokens 696(a) to (d) may be directly stored in various entries of ledger 668 and used to update the various accounts of ledger 668) and one, some, or all allocations, transfers, and/or exchanges involving one or more accounts on ledger 668 may be documented on the tokens and stored within ledger 668. When the transaction is to be permanently recorded on blockchain 692 (e.g., as one or more records 694(a) to (d)), such tokens may be communicated to blockchain 692. Blockchain 692 may then integrate the tokens as one or more of records 694(a) to (d) or a portion thereof.

Accordingly, the tokens may be quickly integrated within the records of the blockchain, conserving processing resources used in the creation of such records and, additionally, providing for additional data security of the various users by anonymizing data on the blockchain. Tokenization may further allow for the platform to prevent undesired parties from stealing data off of the blockchain, by only allowing for trusted validators that can decipher the tokenized data (e.g., validators that may possess a key to decipher the tokenized data) from validating the transaction. Utilizing tokenized data on the blockchain allows for further validation of transaction by matching data stored by, for example, the merchant, on a user device, and/or on other such devices, further preventing transaction fraud. Thus, in certain such embodiments, such data may be tokenized according to various external party techniques (e.g., that of a credit card provider or that of a supermarket chain) in order to allow for any such data generated by transactions that are associated with such parties to be eligible for digital currency mining/minting on blockchain 692. Such a technique is an improvement over simply writing data onto the blockchain for validation, as such data is often unique to the blockchain and, thus, is unable to be further verified with merchant data, user device data, and/or other such data. Furthermore, as such transaction tokens are typically of a standard format, validation may be simplified, further conserving resources (e.g., validators of blockchain 692 may be optimized to validate according to the format of the token). Furthermore, the format of the transaction token may be proprietary to the platform and to associated transactions, allowing for security benefits.

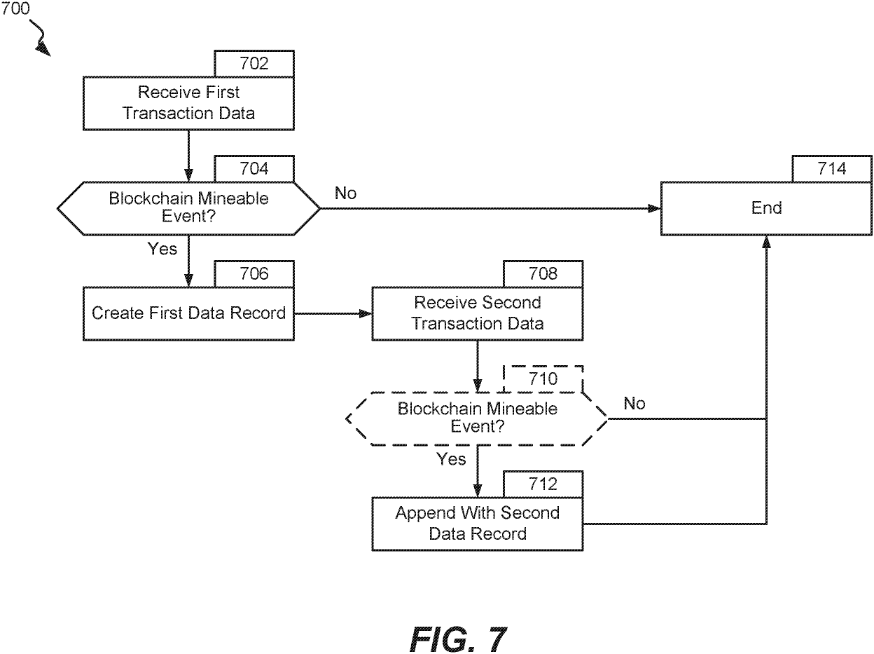

FIG. 7 is a process flowchart corresponding to a technique utilizing a physical action blockchain, in accordance with some embodiments. FIG. 7 illustrates technique 700 for mining digital currency via a physical action blockchain. In various embodiments, portions of technique 700 may be performed with any of the components described herein (e.g., the platform, blockchain, user device, point of sale device, and/or other such components).

In 702, first transaction data associated with a first transaction is received (e.g., by the platform). The first transaction data may be associated with a transaction for goods or services and may include data directed to details of the transaction (e.g., the identity of the parties of the transaction, the amount of the transaction, the services or products provided, the method of payment used for the transaction, and/or other such details). The first transaction data may be generated by a user device (e.g., by a payment application on the user device), by a merchant (e.g., via a point of sale device through processing of a payment device), and/or by another party (e.g., a third party fulfillment application). In certain embodiments, the first transaction data may be automatically generated based on the processing of a payment device.

The first transaction data may indicate the identity of the customer, the payer of the transaction, and/or the identity of the party that receives the mined/minted digital currency. In various embodiments, the first data record created in 706 and/or the second data record created in 712 may utilize the identity data within the first transaction data to indicate the identity of the party that receives the mined/minted digital currency. In various embodiments, the second transaction data may, additionally or alternatively, indicate the identity of the party. In certain embodiments, tokenized data utilized for processing the transaction may include such data. In such embodiments, the identity data within the tokenized data may be utilized within the data records to indicate the identity of the party. Thus, for example, the tokenized data may be stored within the data record and, to validate the identity of the party, such tokenized data may be analyzed. In certain embodiments, the platform may determine the identity of the party that receives the mined/minted digital currency and indicate the account of such a party on the corresponding data records of the blockchain.

In certain embodiments, a determination may be made as to whether the first transaction data indicates fraud. Thus, for example, the first transaction data received may be compared to other transaction data received. The data may be compared to determine if there is a pattern indicating fraud. Machine learning techniques may be utilized to determine if the data is consistent with one or more patterns indicating fraud. In certain other embodiments, the data records may be generated from the transaction data and may be recorded onto the blockchain. Validators may then analyze the data records to determine if the data record indicates fraud. In various embodiments, such fraud analysis may occur at any point within the techniques described herein.

In 704, a determination is made, based on the first transaction data, as to whether the first transaction is a blockchain mineable event. Thus, for example, the platform analyzes the first transaction data to determine if the transaction is a blockchain mineable event. For tokenized transaction data, a transaction token may be received with data indicating the parameters of the transaction and such parameters may be analyzed.

A blockchain mineable event may be an event that may allow for mining/minting of digital currency on the blockchain. Thus, for example, in various embodiments, a blockchain mineable event may be a transaction that utilizes a specific payment device, is conducted within a specific jurisdiction allowing for mining of digital currency, meets minimum transaction requirements (e.g., a minimum transaction amount, is a transaction associated with specific merchants, is conducted within specific timeframes, and/or other such requirements), and/or satisfies another such criteria. In certain embodiments, the blockchain mineable event may be a tokenized transaction that allows for creation of tokenized data records on the blockchain.

In another embodiment, a blockchain mineable event may be a physical action such as performing of labor (e.g., providing delivery, providing agreed upon services, and/or other such labor or services) and the first transaction data may indicate details of such labor to be performed and/or has been performed. In such an embodiment, a blockchain mineable event may be labor that meets requirements for the mining of currency (e.g., is labor that is performed in response to a request).

If the first transaction data indicates that the transaction is not a blockchain mineable event, technique 700 ends at 714. If the first transaction data indicates that the transaction is a blockchain mineable event, a first data record may be generated in 706. The first data record may include details of the transaction and may be a data record on the blockchain and/or may be stored within temporary storage (e.g., within a ledger) for later integration into the blockchain as needed.

In various embodiments, the first data record may refer to the mining/minting of a digital currency based on the transaction. Thus, for example, the first data record may indicate the amount of digital currency to be mined (e.g., for physical action blockchains where the amount of digital currency to be mined is a percentage of a transaction, it may indicate the value of the transaction and/or the amount of digital currency to be mined). In certain embodiments, the first data record may be automatically generated based on receiving the first transaction data and the determination of a blockchain mineable event. That is, the first data record may be provided (e.g., by a merchant device, user device, and/or point of sale device) when the transaction is initiated and the platform may accordingly receive the first data record. The platform may then automatically determine that the transaction data indicates a blockchain mineable event. The first data record may then automatically be created. Thus, in certain embodiments, data records are automatically created on or for the blockchain (e.g., created and stored in temporary storage for later incorporation into the blockchain, according to the techniques described herein), in connection with transfer or minting/mining of digital currency, based on transaction data received. Such a technique may, thus, allow for transfer and/or mining of digital currency without affirmative actions to do so (e.g., without a user purposely running a program on a mining rig). Thus, such a technique may simplify the acquisition and mining of digital currency.

The first data record may also indicate the time of generation of the data record, the time of the transaction, the status of the transaction, the expected completion time of the transaction, the parties of the transaction, the backstop of the digital currency mined/minted, whether the transaction and/or the minting/mining of the digital currency is provisional (e.g., yet to be finalized) or final, and/or other such details. Other such details may include, for example, in certain embodiments, payment provided by a merchant for the service of utilizing the payment device (e.g., a swipe fee). The first data record may indicate that all or a certain portion of such payment may be held to backstop the digital currency and, thus, provide for a guaranteed minimum redemption value for a holder of the digital currency. Such an amount may, for example, be held in a trust account or another such account that may preserve the value of the payment received. Accordingly, the digital currency mined/minted may indicate the amount of the service payment that is held to provide a backstop for the digital currency.

In 708, second transaction data associated with the first transaction is received. The second transaction data may be received via any of the techniques described herein. The second transaction data may indicate an update in the status of the first transaction. Thus, for example, the second transaction data may indicate that a payment transaction has been closed out (e.g., that payment has been received for the transaction as specified), that labor has been performed, and/or that the transaction has otherwise finished or been canceled.

After receiving the second transaction data, a determination may be made, based on the second transaction data, as to whether the second transaction data indicates that first transaction continues to be a blockchain mineable event, in optional 710. Such a determination may be made by analyzing the second transaction data according to the same or different factors as that in 704. Thus, for example, the platform analyzes the second transaction data to determine if the second transaction data indicates that the first transaction is a transaction that utilizes a specific payment device, is conducted within a specific jurisdiction allowing for mining of digital currency, meets minimum transaction requirements (e.g., a minimum transaction amount, is a transaction associated with specific merchants, is conducted within specific timeframes, and/or other such requirements), and/or satisfies another such criteria. In various embodiments, analysis of the second transaction data may determine if certain parameters (e.g., transaction amount, parties to the transaction, and/or other such parameters) remain consistent from the first transaction.

Variously, analysis within 704 and 710 may analyze the same or different factors, and may apply the same or different analysis (e.g., thresholds). In certain embodiments, 710 may be an optional portion of technique 700. Thus, for example, a determination may be made that the second transaction data indicates that the transaction is unchanged from the terms indicated within the first transaction data. Otherwise, a determination may be made that the second transaction data indicates that the terms of the transaction meets thresholds for a blockchain mineable event. Such thresholds may include, for example, jurisdictions requirements, a minimum transaction amount, determining that the transaction utilizes specific payment devices, transactions involving specific merchants, transaction within specific timeframes, and/or other such thresholds. If the second transaction data indicates that the transaction is not a blockchain mineable event, technique 700 ends at 714. Otherwise, the technique proceeds to 712. For embodiments where 710 is not performed, the technique may automatically proceed to 712.

The second data record generated in 712 may include details of the first transaction per the second transaction data. The second data record may be recorded on the blockchain and/or may be stored within temporary storage (e.g., within a ledger) for later integration into the blockchain as needed. In certain embodiments, the second data record may indicate finalization of the first transaction and, thus, the second data record may be appended to the blockchain and may reference the first data record (which may be previously recorded onto the blockchain). In certain other embodiments, the second data record may be recorded onto the blockchain and, at the same time, the first data record may also be recorded onto the blockchain (e.g., transferred from temporary storage), based on the finalization of the first transaction. In such embodiments, the first data record and the second data record may be written together as a single data record or may be written as a plurality of different data records. In other embodiments, the second data record may, additionally or alternatively, be stored within temporary storage and may be recorded onto the blockchain at a later period of time.

In various embodiments, recording of the first and/or second data record onto the blockchain may result in the finalization of the mining/minting of the digital currency based on the transaction. Thus, the first and/or second data record may indicate the amount of digital currency mined/minted.

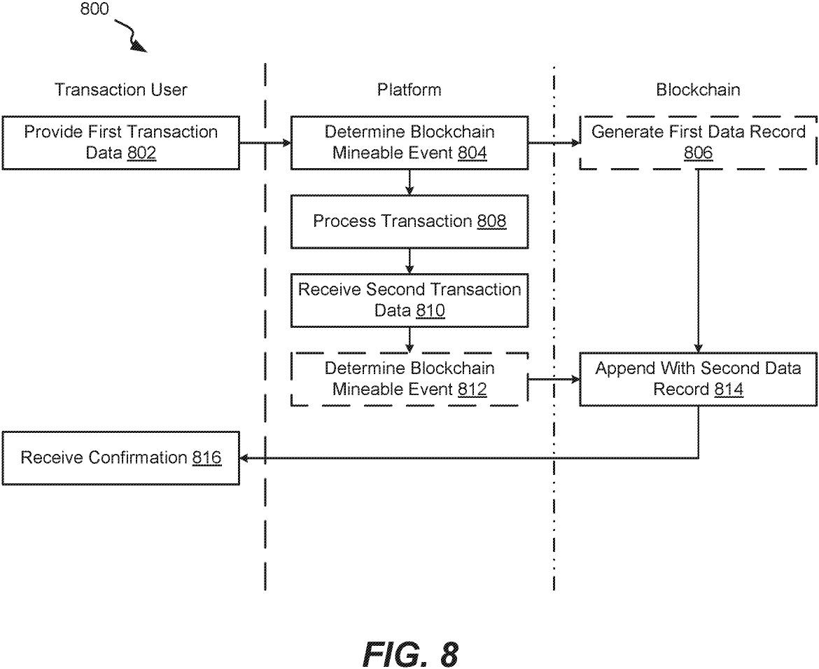

FIGS. 8-12 are process flowcharts corresponding to further techniques utilizing physical action blockchains, in accordance with some embodiments. FIGS. 8-12 may be process flowcharts where portions of the techniques are performed by a transaction user (e.g., one of a merchant, payment device, user, payment provider such as a bank, and/or another such non-platform or blockchain party), by the platform, or on the blockchain. While the techniques of FIGS. 8-12 are described in the context of a transaction that allows for mining/minting of a digital currency, it is appreciated that other embodiments based on other physical actions may utilize the techniques described herein, such as for mining/minting of digital currency based on physical labor, action, or transaction performed (e.g., in response to requests from other users and/or from a merchant).

In 802 of technique 800 of FIG. 8, a transaction may be conducted between a merchant and a customer. The transaction may include the charging of a payment device of the customer for the goods and/or services provided by the merchant. Based on the transaction and/or the charging of the payment device, first transaction data may be generated. The first transaction data may be transaction data as described herein and may be communicated to the platform.

The platform receives the first transaction data in 804 and determines if the first transaction data indicates a blockchain mineable event in 804, according to the techniques described herein. If the first transaction data indicates a blockchain mineable event, a first data record may be generated on the blockchain in optional 806. In certain other embodiments, the data record may not be directly generated on the blockchain and may, instead, be stored within temporary storage.

In 808, the transaction may be processed. In certain embodiments, the payment device may be associated with the platform (e.g., may be issued by the platform). Processing of the transaction may include, for example, the platform providing payment to the merchant for the transaction or providing credit to the customer for the transaction, based on usage of the payment device by the customer. Additionally, confirmation of payment may be provided to the customer. The platform may receive compensation for the payment from a third party bank, may deduct the funds from an account of the customer on the platform, and/or may otherwise receive compensation for payment provided to the merchant.

In 810, second transaction data may be received by the platform. In certain embodiments, the second transaction data may be generated by the transaction user. In various embodiments, the second transaction data may be generated by, for example, the merchant (e.g., from an inventory management system of the merchant), the customer (e.g., from a user device of the customer’s), from a financial institution (e.g., confirming compensation for the credit provided to the customer and/or for payment provided to the merchant), and/or from another such party. The second transaction data may indicate the status of the first transaction associated with the first transaction data. Thus, the second transaction data may indicate whether the first transaction has been canceled, is incomplete, has been completed, has been processed, and/or is in another state.

A determination may be made as to whether the second transaction data indicates that the first transaction is still a blockchain mineable event in optional 812. Such a determination may be according to the techniques described herein. A determination that the second transaction data indicates a blockchain mineable event may result in the creation of the second data record and the appending of the second data record to the blockchain, in 814. The second data record may be created according to the techniques described herein. In various embodiments, the second data record may be directly appended to the blockchain, or may be first stored within temporary storage before being provided to the blockchain. In certain such embodiments, the second data record may be recorded onto the blockchain along with the first data record (e.g., by recalling the first data record from temporary storage), or the first data record may be recorded at an earlier time and the second data record may reference the first data record to associate the second data record with the first data record. Other embodiments may hold both the first data record and the second data record within temporary storage and may record both the first data record and the second data record at a later period in time.

In embodiments where the first data record and the second data record are recorded onto the blockchain at approximately the same time, the first data record and the second data record may be combined into one data record on the blockchain that includes the data of both data records. Such a technique reduces the amount of data records on the blockchain, reducing resource usage and allowing for less processing intensive validation as validators are only required to refer to a lower number of data records on the blockchain to perform validation. Such a technique may be appropriate for transactions that includes a plurality of steps to finalize, leading to less wasted resources for mining/minting from such transactions. In certain such embodiments where the first transaction data and the second transaction data include tokenized data, a plurality of tokens may be stored within such a data record. The blockchain may, for tokens that do not include time data, indicate which of the tokens was first received and which of the token was received later, in order to reduce the complexity of validation.

In various embodiments, recording of the second data record onto the blockchain may indicate that the transaction has been finalized and that the digital currency resulting from the transaction has been minted or mined. Based on the minting or mining of the digital currency, a confirmation of the minting or mining may then be provided to a transaction user in 816.

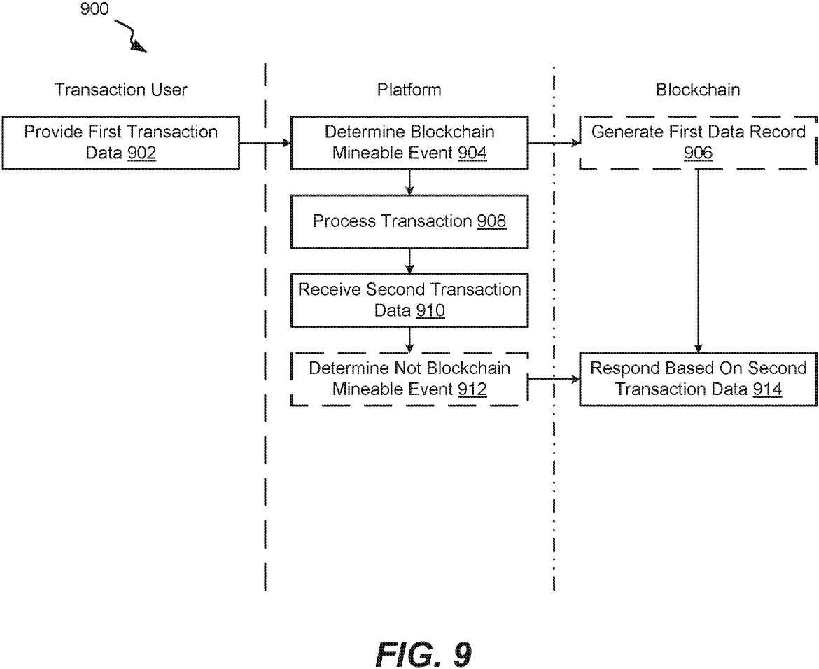

FIG. 9 illustrates technique 900. In FIG. 9, 902, 904, 906, 908, and 910 are similar to 802, 804, 806, 808, and 810, respectively. In 912, based on the second transaction data received in 910, a determination is made that the second transaction data indicates that the first transaction is no longer a blockchain mineable event. Such a determination may be based on, for example, that the transaction has been canceled, that the transaction and/or one or more of the parties to the transaction are located within a jurisdiction that does not allow for minting/mining of digital currency (e.g., in certain embodiments, such a determination may not be initially made, but may instead only be made when the transaction is finalized, in order to conserve resources), that the transaction no longer meets the minimum threshold for being a blockchain mineable event (e.g., a minimum transaction amount), and/or another such determination.

Based on such a determination, a response may be provided in 914. In certain embodiments, a second data record may be generated indicating that no digital currency was mined/minted. Such a second data record may reference the first data record. In embodiments where the first data record is stored in temporary storage, the response may be deletion of the first data record from temporary storage, with no data records generated on the blockchain, in order to conserve resources. In another embodiment, both the first data record and a generated second data record may be posted onto the blockchain, as either a single data record or separate data records, and the second data record may indicate that no digital currency was mined/minted. In a further embodiment, where the digital currency is mined/minted with the first data record posted onto the blockchain, the second data record may indicate that the mined/minted digital currency is burned and is no longer a part of the digital currency ecosystem.

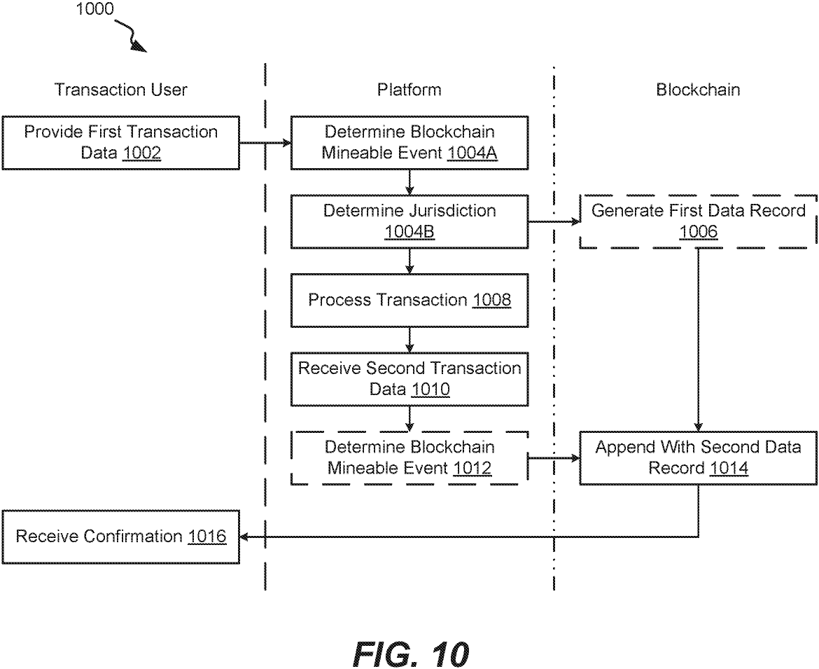

FIG. 10 illustrates technique 1000. In FIG. 10, 1002, 1004A, 1006, 1008, 1010, 1012, 1014, and 1016 are similar to 802, 804, 806, 808, 810, 812, 814, and 816, respectively. In technique 1000, a further determination may be made in 1004B as to the jurisdiction that the transaction, the merchant, the customer, and/or another party or portion of the transaction is located within. In various embodiments, the jurisdiction may inform whether to generate data records for the blockchain. Thus, if one of the location of the transaction, the merchant, the customer, and/or another party or portion of the transaction is located within a jurisdiction that does not allow for the mining/minting of digital currency, data records may not be generated on the blockchain as no mining/minting of the digital currency will occur. Otherwise, data records may be generated according to the techniques described herein.

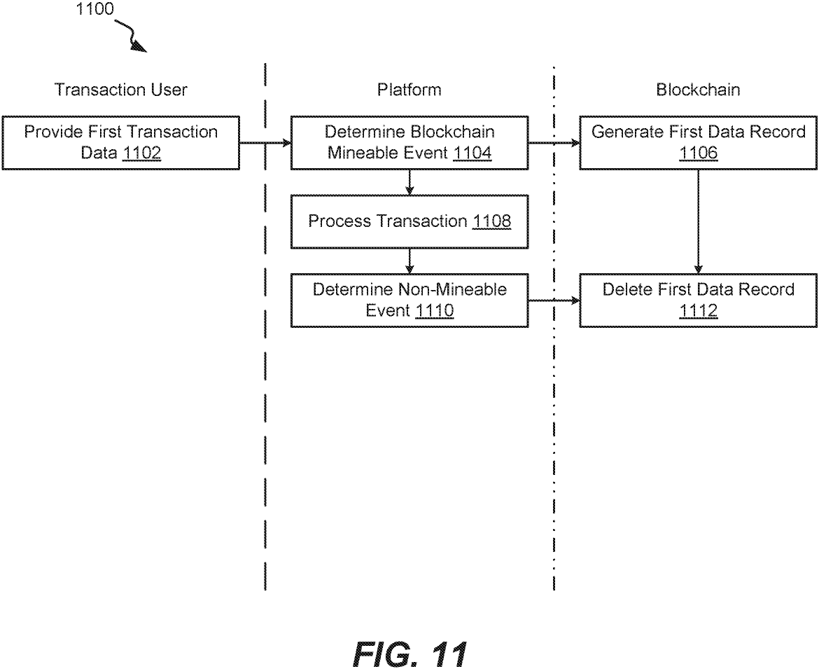

FIG. 11 illustrates technique 1100. In FIG. 11, a determination may be made in 1110, after processing of the transaction in 1108, that the transaction is a non-mineable event. Such a determination may be due to, for example, rejection of the transaction, determining that the transaction does not meet transaction minimum thresholds, does not qualify as a physical action for mining/minting, and/or another reason for not finalizing the transaction. Accordingly, the first data record generated in 1106 may be deleted in 1112. In various embodiments, the first data record may be stored in temporary storage and may accordingly be deleted without being written to the blockchain.

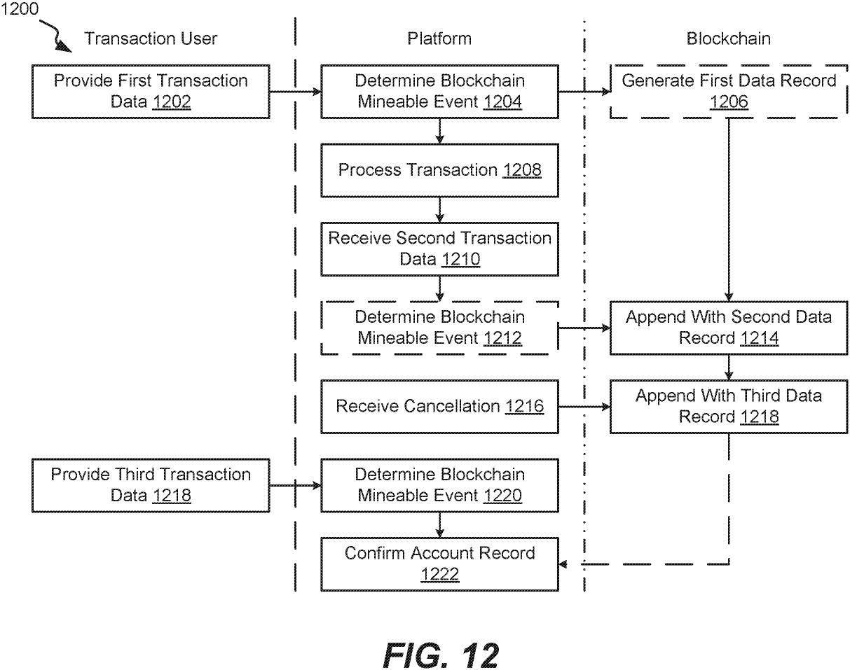

FIG. 12 illustrates technique 1200. In FIG. 12, 1202, 1204, 1206, 1208, 1210, 1212, and 1214 are similar to 802, 804, 806, 808, 810, 812, and 814, respectively. In the embodiment of FIG. 12, creation and appending of the second data record to the blockchain results in the mining/minting of digital currency.

After the creation of the second data record on the blockchain, a cancellation for the first transaction is received in 1216. In the example of technique 1200, the cancellation may be received after the second data record has been finalized (e.g., due to an extended cancellation period). Based on the cancellation received, a third data record may be created and appended to the blockchain in 1218. The third data record may indicate cancellation of the transaction and, thus, cancellation (e.g., burning or removal from circulation) of the mined/minted digital currency and/or a debit against the user’s (e.g., customer’s) account for the amount of the mined/ minted digital currency.

In various embodiments, the account of the user may be confirmed to determine if the debit would result in a negative balance. If the user account includes enough resources (e.g., digital currency and/or other forms of currency) to allow for the debit, the amount of digital currency taken out of circulation due to the cancellation may be debited from the account of the user. Otherwise, the user’s account may be reduced to zero, and any digital currency accordingly taken out of circulation (e.g., up to the zero amount), and a resulting negative balance may be noted within the user’s data on the platform. The third data record may indicate the digital currency that is taken out of circulation.

In such an example, where the digital currency mined/minted in 1214 is already in circulation, third transaction data may be received in 1218 and a blockchain mineable event may be determined in 1220. Typically, a data record is created to start the process of mining/minting digital currency for the transaction associated with the third transaction data. However, in technique 1200, the account record of the user may first be confirmed in 1222. As there is a negative balance within the account record, a data record may not be generated and/or a data record may be generated indicating only a portion of the typical digital currency to be mined/minted (e.g., to account for the negative balance). Accordingly, the negative balance may be maintained until the deficit has been satisfied.

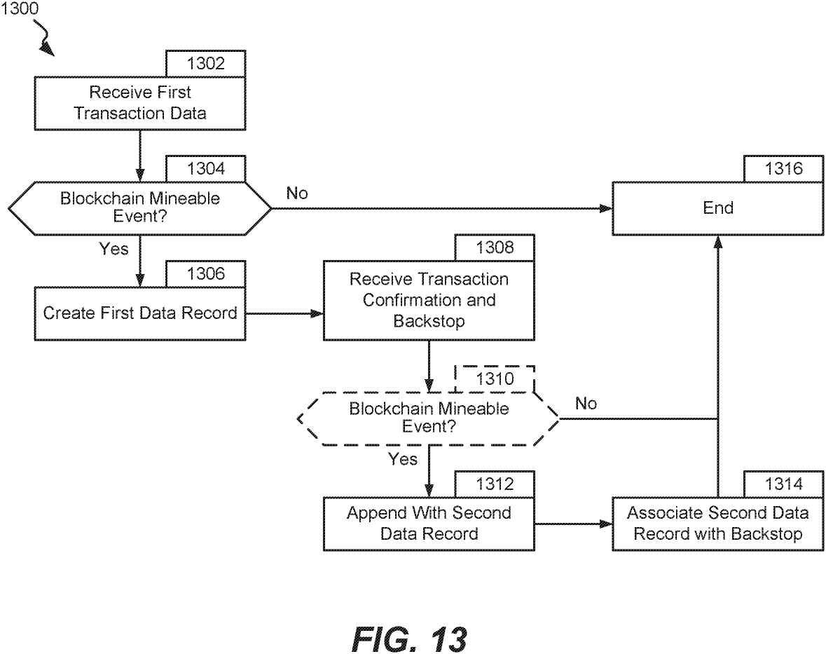

FIG. 13 is a process flowchart corresponding to another technique utilizing a physical action blockchain, in accordance with some embodiments. FIG. 13 illustrates technique 1300. In FIG. 13, 1302, 1304, 1306, 1308, 1310, and 1312, are similar to 702, 704, 706, 708, 710, and 712, respectively. Technique 1300 illustrates the backstopped of digital currency created due to physical action, as described herein. As such, the second data record may be associated with a backstop in 1314. The association with the backstop may be indicated within the second data record. The backstop may be, as described herein, a portion of a transaction fee provided to the platform for processing the transaction and held in trust in order to provide the necessary backstop for the digital currency mined/minted.

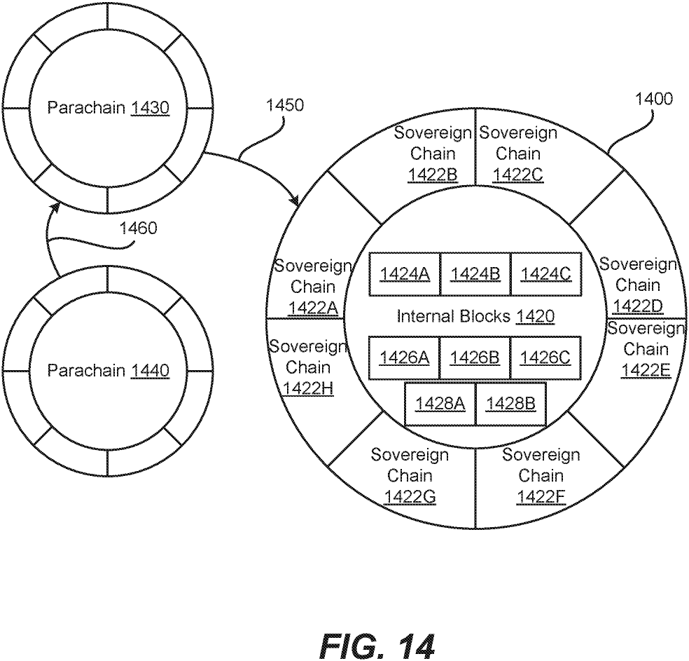

FIG. 14 is an example blockchain, in accordance with some embodiments. FIG. 14 illustrates sovereign chain 1400 that may be a blockchain of a cryptocurrency associated with the platform. Sovereign chain 1400 may include internal blocks 1420, sovereign chain nodes 1422A to 1422F, validator nodes 1424A to 1424C, collator nodes 1426A to 1426C, and archive nodes 1428A and 1428B. The various nodes associated with blockchain 1400 may be electronic devices, or portions thereof, configured to communicate between the various nodes (e.g., electronic devices) supporting blockchain 1400 to provide for services on blockchain 1400.

Internal blocks 1420 may include various collator nodes, validator nodes, inputs, transactions, and/or other data blocks (e.g., for implementing the blockchain and/or coin), as described herein. Internal blocks 1420 are configured to store records of transactions involving the coin. Thus, the records of internal blocks 1420 may include a history of the usage of the coin.

Sovereign chain nodes 1422A to 1422F may be configured to interface with other chains such as parachain 1430, via bridge 1450. In such a manner, parachain 1430 may be added and integrated with sovereign chain 1400. Parachain 1430 may, thus, obtain a stake of the coins. Parachain 1430 may provide, for example, computing power, security protocols, and/or other processing abilities for sovereign chain 1400. In such a manner, the integration of parachain 1430 may increase the computing power for processing transactions within the platform. Parachain 1430 may be configured to interface with additional other parachains, such as parachain 1440, via bridge 1460. Accordingly, sovereign chain 1400 may be linked to a plurality of parachains, allowing for shared/increased computing resources and system complexity. In various embodiments, the parachains may be external or internal (e.g., internal to the platform) parachains. In certain embodiments, various bridges may allow for connection to other blockchains and/or services, such as exchanges, ledgers, and/or other services.

In certain embodiments, one or more of sovereign chain nodes 1422A to 1422F may be configured as sync nodes. Such sync nodes may be, for example, utilized as viewport nodes on blockchain 1400 and configured to allow outside entities, such as the platform and/or parachain 1430, to read from the nodes and/or to read the data blocks of blockchain 1400, but not mutate/write to the blockchain 1420.

Validator nodes 1424A to 1424C may be nodes of blockchain 1400 configured to validate data blocks of blockchain 1400. Validation of data blocks of blockchain 1400 may include confirming that the data blocks are valid (e.g., not indicative of fraud), that the data within the data blocks support a determination of a blockchain mineable event, and/or other such validation.

Collator nodes 1426A to 1426C may be nodes of blockchain 1400 configured to create the data blocks on blockchain 1400. Thus, collator nodes 1426A to 1426C may receive data from various devices (e.g., user devices, point of sale devices, merchant devices, and/or other such devices) and/or from the platform and create data blocks on blockchain 1400 based on such data and according to the techniques described herein.

Archive nodes 1428A and 1428B may be nodes of blockchain 1400 configured to archive data that is not finalized on blockchain 1400. Thus, for example, the data may be received from various devices (e.g., user devices, point of sale devices, merchant devices, and/or other such devices) and/or from the platform that may be not written on the data blocks of blockchain 1400, for various reasons (e.g., for security reasons, to save on memory, and/or for another such reason). Such data may be archived. In various embodiments, the data may be archived within one or more databases associated with blockchain 1400. Data records on blockchain 1400 may refer to such archived data, which may be available for validation, but not stored on blockchain 1400 itself, to conserve memory resources. Such archived data may include any such data described herein.

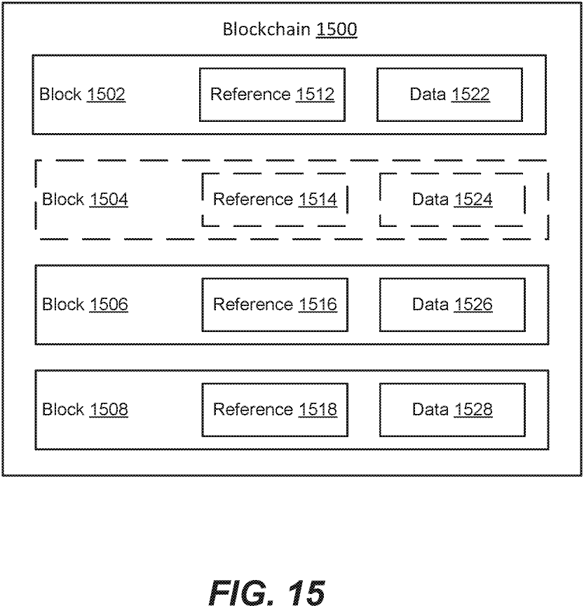

FIG. 15 illustrates a block diagram of an example of a physical action blockchain, in accordance with some embodiments. FIG. 15 illustrates blockchain 1500 that includes a plurality of data blocks 1502, 1504, 1506, and 1508. Data blocks 1502, 1504, 1506, and 1508 may be data blocks associated with one or more physical actions or transactions. Data blocks 1502, 1504, 1506, and 1508 may each include reference 1512, 1514, 1516, and 1518, respectively, and data 1522, 1524, 1526, and 1528, respectively. In a certain embodiment, a plurality of data blocks 1502, 1504, 1506, and/or 1508 may be associated with a transaction and/or a physical action. Thus, as a transaction and/or physical action progresses (e.g., from request, to execution, to completion), data blocks may be appended to blockchain 1500 to illustrate the receipt of additional data associated with the transaction and/or physical action and allow for the determination of certain aspects of the transaction (e.g., whether it has been completed or finalized).

References 1512, 1514, 1516, and 1518 may include references to the transaction and/or physical action. Thus, references 1512, 1514, 1516, and 1518 may identify the transaction and/or physical data (e.g., via a transaction ID) and allow for the determination that each of data blocks 1502, 1504, 1506, and 1508 are associated with the transaction and/or physical data.

Data 1522, 1524, 1526, and 1528 may include data directed to the transaction and/or physical data (e.g., whether the transaction is in progress, has finished, whether payment has been provided, whether compensation is confirmed, and/or other such data). Data 1522, 1524, 1526, and 1528 may, thus, be data received from the merchant, customer, and/or another party at various points of the transaction and/or physical action request (e.g., data 1522 and data block 1502 may be received and created at the start of the transaction and data blocks 1504, 1506, and 1508 as well as data 1524, 1526, and 1528 may be further blocks appended onto blockchain 1500 due to receipt of sensor data, transaction data, and/or other data during performance of the transaction). Accordingly, the structure of blockchain 1500 allows for analysis of data 1522, 1524, 1526, and 1528 to determine if a transaction has been completed and, thus, whether digital currency has been mined/minted.

In various embodiments, certain blocks may be optional and/or may be stored on temporary storage, according to the techniques described herein. For example, in blockchain 1500, block 1504 may first be held in temporary storage. As such, block 1504 may not be appended onto blockchain 1500 until after the data block has been generated. In certain such embodiments, block 1504 may not be appended onto blockchain 1500 at all. Thus, for example, block 1504 may be directed to an intermediate step of the transaction and/or physical action (e.g., the scanning of an item for sale). Block 1504 may be created as a data record for such an intermediate step. In a certain step of the transaction, block 1506 may be created and creation of block 1506 may include verifying the existence block 1504 to verify that the intermediate step has been performed. Once verified, block 1506 may be accordingly appended onto blockchain 1500. Alternatively or additionally, block 1506 may incorporate block 1504 according to the techniques described herein.

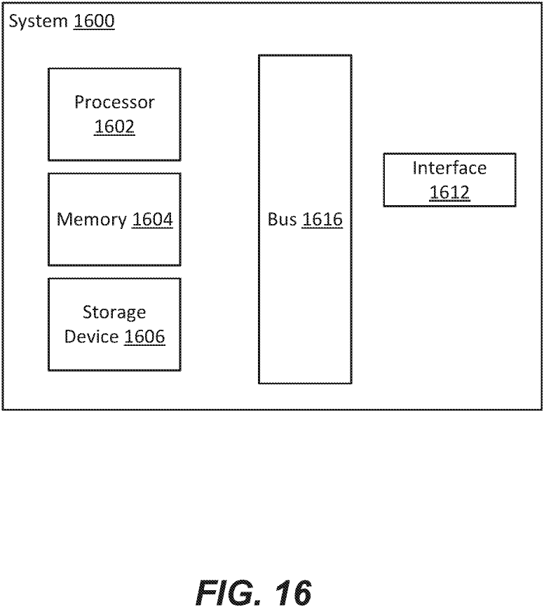

FIG. 16 illustrates a block diagram of an example computing system, in accordance with some embodiments. According to various embodiments, a system 1600 suitable for implementing embodiments described herein includes a processor 1602, a memory module 1604, a storage device 1606, an interface 1612, and a bus 1616 (e.g., a PCI bus or other interconnection fabric.) System 1600 may operate as variety of devices such as a server system such as an application server and a database server, a client system such as a laptop, desktop, smartphone, tablet, wearable device, set top box, etc., or any other device or service described herein.

Although a particular configuration is described, a variety of alternative configurations are possible. The processor 1602 may perform operations such as those described herein. Instructions for performing such operations may be embodied in the memory 1604, on one or more non-transitory computer readable media, or on some other storage device. Various specially configured devices can also be used in place of or in addition to the processor 1602. The interface 1612 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

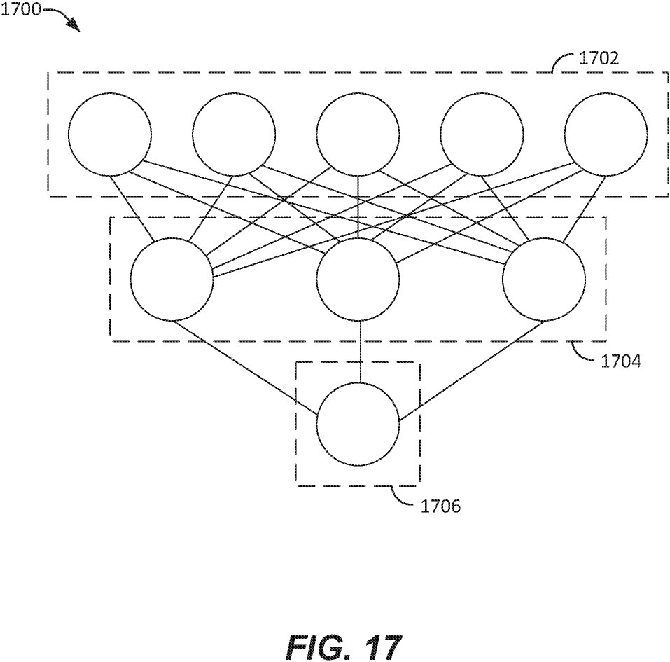

FIG. 17 illustrates an example of a neural network, configured in accordance with some embodiments. FIG. 17 illustrates a neural network 1700 that includes input layer 1702, hidden layers 1704, and output layer 1706. Neural network 1700 may be a machine learning network that may be trained to perform the techniques described herein (e.g., determining whether transaction data received is indicative of fraud).

Neural network 1700 may be trained with inputs. Input layer 1702 may include such inputs. Such inputs may include, for example, transaction data, physical actions requested, social contacts of the user, location data of the user, groups associated with the user, and/or other such data described herein. Hidden layers 1704 may be one or more intermediate layers where logic is performed to determine various aspects of the data (e.g., determination of appropriate groups for the user). Output layer 1706 may result from computation performed within hidden layers 1704 and may output, for example, determinations of fraud, whether certain transaction qualify for mining/minting of digital currency, whether a transaction has been finalized, and/or other such outputs.

Machine learning may be utilized to determine parameters (e.g., geofences) of the techniques described herein and/or to perform the techniques themselves. In various embodiments, machine learning may continuously or periodically refine the determinations based on data received (e.g., additional transaction data received).

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

1. A system comprising:
a gateway, communicatively coupled to a network;
a blockchain comprising a plurality of data records;
a processor; and
a memory, communicatively coupled to the gateway, the processor, and the blockchain and configured to cause the processor to perform operations comprising:
receiving, with the gateway, first transaction data associated with a first transaction;
processing, based on the first transaction data, the first transaction;
determining that the first transaction is a blockchain mineable event;
generating, based on the determining that the first transaction is a blockchain mineable event, a first data record;
receiving, with the gateway, second transaction data associated with the first transaction, wherein the second transaction data indicates that the first transaction has been finalized; and
generating, based on the second transaction data, a second data record on the blockchain, wherein the second data record comprises mining data associated with mining of a first resource amount of the blockchain.

2. The system of claim 1, wherein the second data record comprises a transaction amount, and wherein the first resource amount of the blockchain is based on the transaction amount.

3. The system of claim 1, wherein the operations further comprise:
determining, based on the second transaction data, that the second transaction data indicates that the finalized first transaction is a blockchain mineable event, wherein the appending the blockchain with the second data record is further based on the determining that the second transaction data indicates that the finalized first transaction is a blockchain mineable event.

4. The system of claim 3, wherein the determining that the second transaction data indicates that the finalized first transaction is a blockchain mineable event comprises:
determining, based on comparing the second transaction data to the first transaction data, that the first transaction is unchanged.

5. The system of claim 3, wherein the determining that the second transaction data indicates that the finalized first transaction is a blockchain mineable event comprises:
determining, from the second transaction data, that the first transaction is for a greater than threshold transaction amount.

6. The system of claim 1, wherein second data record comprises second blockchain data comprising an indication that the first transaction has been completed.

7. The system of claim 1, wherein the first transaction is a payment card transaction, and wherein the first transaction data is generated based on the processing of the payment card.

8. The system of claim 1, wherein the first transaction data is based on payment data from a user account holder, and wherein the second data record indicates that the first resource amount of the blockchain is owned by the user account holder.

9. The system of claim 8, wherein an identity of the user account holder is determined from the first transaction data and/or the second transaction data.

10. The system of claim 1, wherein the operations further comprise:
determining, based on the second transaction data, that the first transaction has been finalized.

11. The system of claim 10, wherein the determining that the first transaction has been finalized comprises determining that a threshold period of time has passed since payment was provided for the first transaction.

12. The system of claim 1, wherein the first transaction is a payment application transaction, and wherein the first transaction data is generated by a payment application.

13. The system of claim 1, wherein the processing the first transaction comprises providing payment for the first transaction.

14. The system of claim 1, wherein the operations further comprise:
storing, within temporary storage, the first data record.

15. The system of claim 14, wherein the operations further comprise:
appending the first data record onto the blockchain.

16. The system of claim 15, wherein the first data record is appending onto the blockchain at substantially the same time period as the generation of the second data record on the blockchain.

17. The system of claim 16, wherein the first data record is incorporated within the second data record, and wherein the generating the second data record comprises accessing the temporary storage for the first data record.

18. The system of claim 1, wherein the first data record is generated on the blockchain, and wherein the first data record comprises first blockchain data associated with the first transaction.

19. The system of claim 1, wherein the first transaction is conducted with a first currency, and wherein the first resource amount is in a digital currency associated with the blockchain.

20. The system of claim 1, wherein the first transaction data comprises first location data, and wherein the operations further comprise:
determining that the first location data indicates a jurisdiction allowing for mining of digital currency.
